(19) United States
(12) Patent Application Publication
(10) Pub. No.: US 2005/0068559 A1
(43) Pub. Date: Mar. 31, 2005

(54) Enabling a heterogeneous imaging device to operate as a homogeneous device

(76) Inventor: Andrew R. Ferlitsch, Tigard, OR (US)

Correspondence Address: Michael F. Krieger;Kirton & McConkie, 1800 Eagle Gate Tower, 60 East South Temple, Salt Lake City, UT, 84111, US

(21) Appl. No.: 10/676,477

(22) Filed: Sep. 30, 2003

(51) Int. Cl. G06F 3/12; G06F 9/44; G06F 13/00; G06F 13/10

(52) U.S. Cl. 358/1.13; 719/324; 358/1.15; 719/321; 719/327

(57) ABSTRACT

Systems and methods for enabling an arbitrary imaging device with compatible capabilities appear homogeneous in an environment with other imaging devices, wherein the arbitrary imaging device would otherwise be considered heterogeneous due to differences in the control of the operations of the various devices. Job control incompatibilities are handled within the imaging device, which employs a virtual job control interpreter that uses a job control device profile (JCDP) for looking up and/or mapping job control commands into internal job control actions. The imaging device is preloaded with a default JCDP which is compatible with the device's corresponding imaging driver.

### BACKGROUND OF THE INVENTION

1. Field of the Invention

The present invention relates to providing a homogeneous image rendering environment. In particular, the present invention relates to systems and methods for enabling an arbitrary imaging device with compatible capabilities appear homogeneous in an environment with one or more other imaging devices and/or imaging sources, wherein the arbitrary imaging device would otherwise be considered heterogeneous due to differences in the control of the operations of the various devices.

2. Background and Related Art

A homogenous printer cluster includes a collection of printers that are compatible in operation and capabilities. Accordingly, the printers are the same printer model or printer model line, have the same capabilities and installed features (e.g., duplex, stapling), have the same imaging data language interpreters (e.g., PDL in printing devices), and have the same job control interpreter.

A print job generated for any one of the printers in the printer cluster can typically be split across any of the printers in the cluster since each printer will interpret and execute the print job in an identical manner. The generated imaging job is typically passed to a cluster handling process on the client and/or server. In this case, the cluster handling process performs the actions of directing the imaging job, or parts thereof, to one or more of the printers in the cluster.

One of the problems with traditional cluster printing techniques is that they cannot handle heterogeneous imaging clusters, which are clusters of devices that are not compatible with one or more capabilities or job control interpretations.

Another problem with traditional cluster printing techniques is that if heterogeneous printing methods are available that provide solutions for handling a diverse set of imaging devices with dissimilar capabilities and job control interpretations, they require integration into the print subsystem upstream from the imaging devices and special components (e.g., software) added to the pre-existing subsystem. Accordingly, an administrator may still run into the problems of simple-clustering, mixed-clustering, and advance-clustering in creating a functional heterogeneous environment.

Thus, while techniques currently exist that utilize cluster printing to render a print job, challenges still exist when the cluster is a heterogeneous imaging cluster. Accordingly, it would be an improvement in the art to augment or even replace current techniques with other techniques.

### SUMMARY OF THE INVENTION

The present invention relates to providing a homogeneous image rendering environment. In particular, the present invention relates to systems and methods for enabling an arbitrary imaging device with compatible capabilities appear homogeneous in an environment with one or more other imaging devices and/or imaging sources, wherein the arbitrary imaging device would otherwise be considered heterogeneous due to differences in the control of the operations of the various devices.

Implementation of the present invention takes place in association with a printing environment that includes a heterogeneous imaging cluster. In at least one implementation, an arbitrary imaging device (e.g., a multi-functional peripheral) with compatible capabilities is made to appear homogeneous with other imaging devices of the cluster.

Job control incompatibilities are handled within the imaging device. The imaging device (e.g., a multi-functional peripheral) employs a virtual job control interpreter that uses a job control device profile (JCDP) for looking up and/or mapping job control commands into internal job control actions. The imaging device is preloaded with a default JCDP which is compatible with the device's corresponding imaging driver (e.g., printer driver).

Job control device profiles are selectively and dynamically downloaded into the imaging device. The JCDP of one or more devices within an imaging cluster (e.g., profiles based on the other device's imaging driver) may be downloaded into the imaging device.

Job control device profiles can be selected at run-time for compatibility with the imaging device. The JCDP of an imaging-device may be dynamically set to conform to other devices (e.g., virtual clustering on the fly, etc.). No modification is required to the imaging job for job control compatibility. A selection of devices by a cluster handling process is independent of the device's job control interpretation. The imaging job only needs modification, if any, for splitting related issues, such as copy and document splitting, color and BW separation, and pool printing processes.

While the methods and processes of the present invention have proven to be particularly useful in the area of rendering print jobs in a printing environment, those skilled in the art will appreciate that the methods and processes can be used in a variety of different types of rendering (e.g., fax, etc.), in a variety of different applications and in a variety of different system configurations to cause an arbitrary imaging device with compatible capabilities appear homogeneous in an environment with one or more other imaging devices and/or imaging sources, wherein the arbitrary imaging device would otherwise be considered heterogeneous due to differences in the control of the operations of the various devices.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative system configuration in accordance with the present invention;

FIG. 3 illustrates a representative management protocol interface for downloading a job control device profile;

FIG. 4 illustrates a flow chart that provides representative processing in accordance with an embodiment of the present invention;

FIG. 5 illustrates a representative management protocol interface for setting a job control device profile;

FIG. 6 illustrates a representative protocol interface for querying a job control device profile;

FIG. 7 illustrates is a flow chart that relates to representative processing for a job control device profile statement lookup;

FIG. 8 illustrates a statement interpretation through an indirect statement lookup;

FIG. 9 illustrates a representative job control device profile set in an imaging job; and

FIG. 10 illustrates a job control device profile set via a job control device profile submission protocol.

### DETAILED DESCRIPTION OF THE INVENTION

The present invention relates to providing a homogeneous image rendering environment. In particular, the present invention relates to systems and methods for enabling an arbitrary imaging device with compatible capabilities appear homogeneous in an environment with one or more other imaging devices and/or imaging sources, wherein the arbitrary imaging device would otherwise be considered heterogeneous due to differences in the control of the operations of the various devices.

Embodiments of the present invention take place in association with an imaging environment that includes at least one imaging device and at least one imaging source, wherein at least one imaging device differs in the control of operations from at least one other imaging device or source. In at least one implementation, an arbitrary imaging device (e.g., a multi-functional peripheral) with compatible capabilities is made to appear homogeneous with one or more other imaging devices and/or imaging sources of the environment.

Job control incompatibilities are handled within the imaging device. The imaging device (e.g., a multi-functional peripheral) employs a virtual job control interpreter that uses a job control device profile (JCDP) for looking up and/or mapping job control commands into internal job control actions. The imaging device is preloaded with a default JCDP which is compatible with the device's corresponding imaging driver (e.g., printer driver).

Job control device profiles are selectively and dynamically downloaded into the imaging device. The JCDP of one or more devices within an imaging cluster (e.g., profiles based on the other device's imaging driver) may be downloaded into the imaging device.

Job control device profiles can be selected at run-time for compatibility with the imaging device. The JCDP of an imaging-device may be dynamically set to conform to other devices (e.g., virtual clustering on the fly, etc.). No modification is required to the imaging job for job control compatibility. A selection of devices by a cluster handling process is independent of the device's job control interpretation. The imaging job only needs modification, if any, for job splitting related issues, such as copy and document splitting, black & white/color separation and pool printing processes.

In the disclosure and in the claims the term “imaging job” shall refer to any type of job that can be rendered at an imaging device. Examples include print jobs, fax jobs, scan jobs, text and/or graphics for printing, document management, and the like.

The following disclosure of the present invention is grouped into two subheadings, namely “Exemplary Operating Environment” and “Providing a Homogeneous Environment.” The utilization of the subheadings is for convenience of the reader only and is not to be construed as limiting in any sense.

### Exemplary Operating Environment

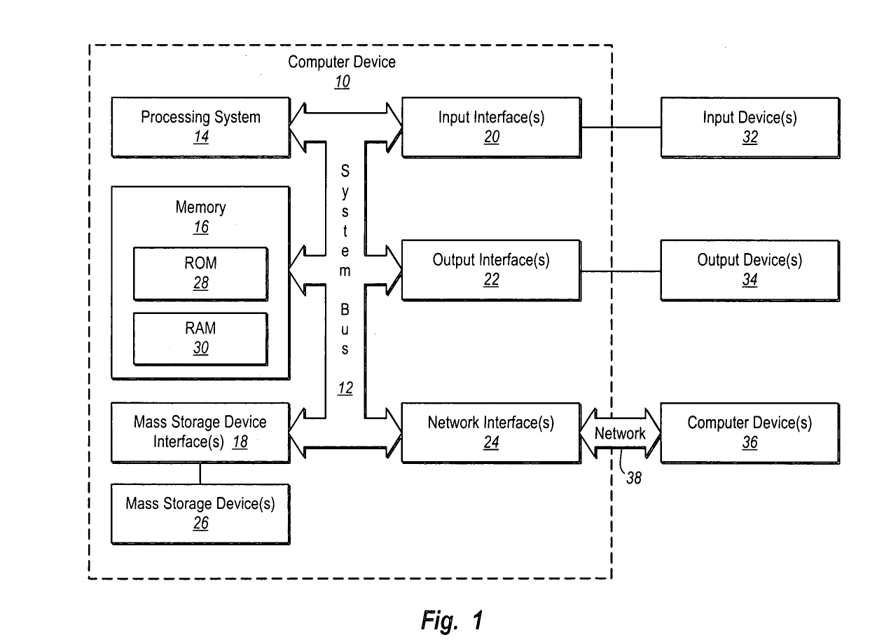

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Those skilled in the art will appreciate that embodiments of the present invention embrace a variety of different system configurations. For example, some embodiments of the present invention embrace local printer environments, network printer environments, remote printer environments, etc. In one embodiment, the system configuration includes one or more imaging devices (e.g., multifunctional peripherals “MFP” or other imaging devices), one or more client computer devices, optionally a server computer device, and a network communication that enables transmitting information relating to imaging jobs. Other embodiments of the present invention embrace one or more computer devices locally or remotely connected to a plurality of imaging devices for the rendering of imaging jobs.

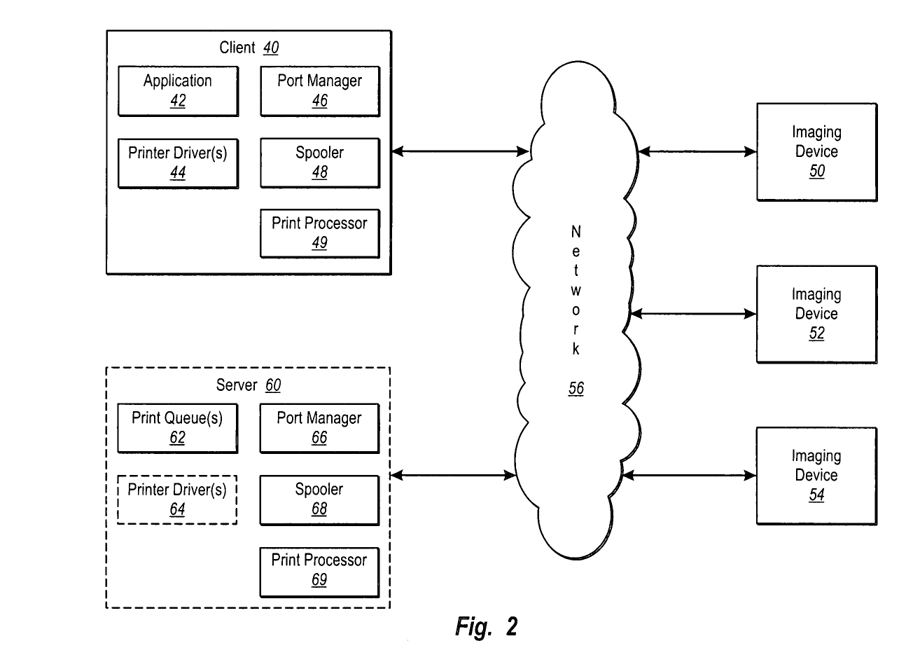

Thus, while those skilled in the art will appreciate that embodiments of the present invention may be practiced in a variety of different environments with many types of system configurations, FIG. 2 provides a representative networked configuration that may be used in association with the present invention. While FIG. 2 illustrates an embodiment that includes a client, three imaging devices, and optionally a print server connected to a network, alternative embodiments include more than one client, less than three imaging devices, more than three imaging devices, no server, and/or more than one server connected to a network. Moreover, other embodiments of the present invention include local, networked, or peer-peer imaging environments, where one or more computer devices are connected to a plurality of imaging devices for rendering imaging jobs. Some embodiments include wireless networked environments, or where the network is a wide area network, such as the Internet.

The representative system of FIG. 2 includes a computer device, illustrated as client 40, which is connected to a plurality of imaging devices 50-54 across network 56. In FIG. 2, imaging devices 50-54 may be any type of imaging device that may be used to render a imaging job. In one embodiment, the capabilities of any one of the imaging devices are heterogeneous to the capabilities of any other printer device (e.g., at least one of the capabilities of one imaging device, such as imaging device 50, are different from the capabilities of another imaging device, such as imaging device 52). In another embodiment, the capabilities of the imaging devices are homogeneous.

As provided above, while imaging devices 50-54 are connected to network 56, embodiments of the present invention embrace the use of imaging devices that are locally connected to a computer device, that are configured in a peer-to-peer imaging environment, or that are configured in a wireless network environment.

In the illustrated embodiment, client 40 includes a software application 42, one or more print drivers 44, a port manager 46, a spooler 48, and a print processor 49. A server 60 is optionally included having, for example, one or more print queues 62, one or more printer drivers 64, a port manager 66, a spooler 68, and a print processor 69.

In one embodiment, an imaging system includes one imaging device and one imaging source, wherein the imaging device and the imaging source are heterogeneous. Accordingly, imaging device and the imaging source are made to appear homogeneous.

Thus, in accordance with the illustrated embodiment and other embodiments of the present invention, an arbitrary imaging device with compatible capabilities is made to appear homogeneous in an environment with other imaging devices, wherein the arbitrary imaging device would otherwise be considered heterogeneous due to differences in the control of the operations of the various devices, as will be further discussed below.

### Providing a Homogeneous Environment

As provided above, the present invention relates to providing a homogeneous image rendering environment. In particular, the present invention relates to systems and methods for enabling an arbitrary imaging device with compatible capabilities appear homogeneous in an environment with one or more other imaging devices and/or imaging sources, wherein the arbitrary imaging device would otherwise be considered heterogeneous due to differences in the control of the operations of the various devices.

The cluster handling processes disclosed herein, which utilize a job control device profile (JCDP) for heterogeneous device clusters, is independent of a method for initiating an imaging job and a method to despool the imaging job to/from the imaging device. For example, an imaging job may be generated by a printer driver from an application. The application converts the document into printing instructions, such as a graphics device interface (GDI) in the Microsoft® Windows family of operating systems. The printing instructions are passed to a printer driver installed on the client and/or server associated with the printing device. The printer driver converts the printing instructions into a printer dependent format (e.g., a raster image or PDL). Alternatively, the document/image format may be directly interpreted by the printer (e.g., direct printing) and there is no preprocessing of the document/image format into a printer dependent format.

Embodiments of the present invention embrace a variety of imaging jobs. For example, embodiments of the present invention embrace a job that is a print, scan, fax or document management job. Further, references to devices that receive or transmit an imaging job, such as an MFP or computing device, will be referred to as imaging devices. Reference to a computing device that constructs and despools an imaging job to or receives from either an imaging device or server will be referred to as a client computing device (e.g., client). Reference to a computing device that manages an imaging device and receives imaging jobs and respool the imaging job to/from an imaging device will be referred to as a server computing devices (e.g., server).

At least some imaging devices (e.g., MFPs) are decomposable into network, host and engine modules. The network module includes components for handling the various communications to/from the device via the network interface, such as management (e.g., SNMP) and imaging protocols (e.g., LPR for printing). The host module includes components for the rendering related operations of an imaging job, such as rasterization of images for printing/copying and scanning for scan/copy. The engine module includes components that describe and monitor the capabilities and status of the device (e.g., config/status), handle processing of an imaging job (e.g., job processing), a spooler for queing/storing and scheduling imaging jobs and a paper processing unit for handling physical paper operations related to the imaging job.

A job processing component may include an imaging job parser process, which respectively process parses the imaging data, separates the imaging job control commands from the imaging job data, and passes the corresponding portions of the imaging job to the job control interpreter and job data interpreter. The job control interpreter parses/interprets the job control commands from the imaging job and sets various settings in internal units according to the requirements specified by the job control commands. These settings typically control the operations of the job data interpreter (e.g., rendering), RIP, paper processing, collator, sheet assembler and finisher. The job data interpreter parses/interprets the job data and converts the job data into an internal intermediate format that describes logical page images, which are then passed to the RIP manager. The RIP manager controls the order and scheduling of logical page images for the RIP.

A job control interpreter unit may be further decomposed into the following subunits: (i) a statement parser; (ii) a statement lookup; (iii) a statement execution; and (iv) a unit setting. The statement parser parses each job control statement from the job control data. Each job control statement, parsed from the job control data, is passed to the statement lookup, which looks up the statement identifier (e.g., opcode, PJL keyword). The statement lookup also includes information on what action the statement is to execute (e.g., duplex printing) and the interpretation of the operands (e.g., long edge vs. short edge binding for duplex printing). The statement execution performs the actions associated with each job control statement, as determined by the job statement lookup subunit. This unit setting performs the communication between the statement execution and all of the downstream components for enabling various settings to reach the downstream components according to the requests from the statement execution subunit. In at least some embodiments, means for interpreting job control statements may be hard-coded into the imaging device.

In one embodiment, this process is applied to one or more page control statements and/or one or more page rendering statements.

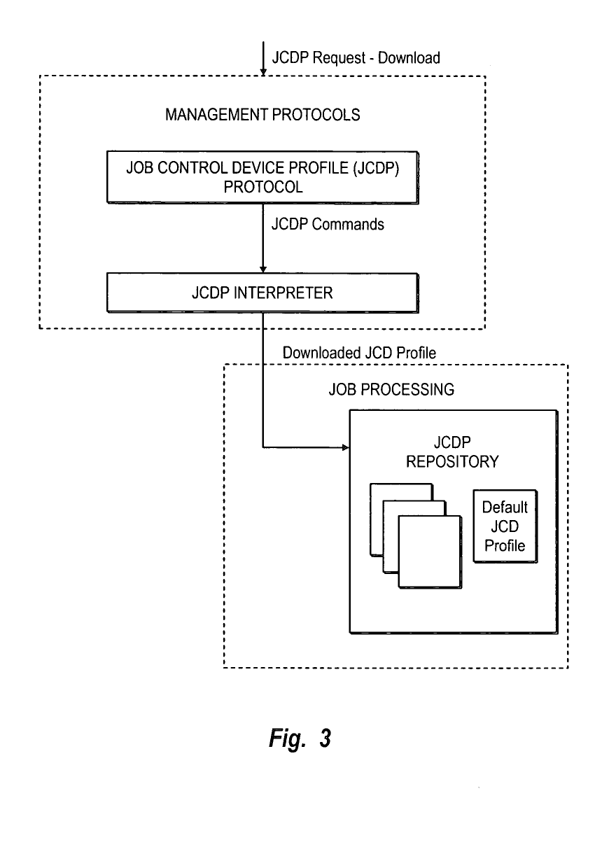

With reference now to FIG. 3, a representative management protocol interface for downloading a job control device profile is illustrated. In at least some embodiments, means for interpreting the job control statements is not hard-coded into the imaging device. Instead, the device uses a virtual job control interpreter. The virtual job control interpreter defines the capabilities of the imaging device, defines a set of settings associated with each capability, uses a common definition language/interface for specifying the capabilities/settings, uses a JCDP interpreter for mapping a set of job control statements to the corresponding capability settings, uses a default JCDP for the imaging driver associated with the imaging device, and uses an active JCDP employed by the JCDP interpreter for mapping a set of job control statements to the corresponding capabilities.

As provided in FIG. 3, the illustrated virtual job control interpreter includes a JCDP protocol or protocol handler, a JCDP interpreter, a JCDP repository and a default and active JCDP. The JCDP protocol handler and JCDP interpreter are part of the management protocol component. The JCDP protocol handles the protocol for receiving JCDP request, such as from an imaging client via the network interface, and passes the JCDP commands obtained from the request to the JCDP interpreter. The JCDP interpreter performs the actions associated with each JCDP command.

The JCDP repository and default/active JCDP are part of the job processing component. The JCDP repository maintains the collection of JCD profiles, a default JCD profile for the imaging driver associated with the imaging device, and an active JCD profile which is the current JCD profile used for interpretation of job control commands. By default, the default JCD profile is the active JCD profile.

In one embodiment, a JCDP request that is handled by the JCDP interpreter is the request to download a JCDP profile. In this embodiment, the JCDP request includes the following: (i) a name of the JCDP profile that uniquely identifies the JCDP profile; (ii) an identification of the imaging device driver(s) associated with the JCD profile; and (iii) the JCD profile embedded in the JCD request.

The JCDP interpreter extracts the embedded JCD profile and stores it in the JCDP repository, using the name of the JCD profile and name of the associated imaging device as means to index and retrieve the profile. The following is a representative example of a JCD profile in accordance with an embodiment of the present invention:

```
# comment: this is a JCD profile for a Sharp AR-275 digital imager
#
Name=Sharp AR-275 Digital Imager
ImagingDriver = Sharp AR-275 PCL5e
          Sharp AR-275 PCLXL,
      Sharp AR-275 PS;
JobControl=@PJL SET COPIES=$COPIES
    {
        set copies = $copies
    }
JobControl=@PJL SET COLLATE=ON
    {
        set collate = on
    }
JobControl=@PJL SET COLLATE=OFF
    {
        set collate = off
    }
JobControl=@PJL SET DUPLEX=OFF
    {
        set duplex = off
    }
JobControl=@PJL SET DUPLEX=ON
    {
        set duplex = on
        set binding = $BINDING
    }
JobControl=@PJL SET BINDING=$BINDING
    {
        set binding = $BINDING
    }
JobControl=@PJL SET STAPLE=2LEFT
    {
        set staple = on
        set number_of_staples = 2
        set binding = shortedge
    }
```

In the above example, $<var> refers to a variable input and the { . . . } is a body of statements associated with the job control command.

In at least some embodiments of the present invention, means for selecting a JCD profile for interpretation of job control commands in an imaging job is not hard-coded in the imaging device. Instead, the JCD profile is user selectable. The JCD profile used to interpret the job control statements in an imaging job is referred to as the active JCD profile. The active JCD profile may (i) persist and apply to all imaging jobs until changed or (ii) not persist and only apply to the current imaging job.

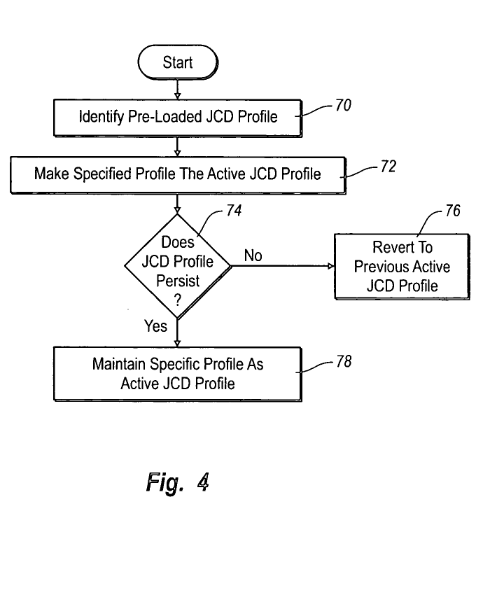

FIG. 4 illustrates a flow chart that provides representative processing in accordance with an embodiment of the present invention. In FIG. 4, the active JCD profile is set via a JCDP request. The request identifies a pre-loaded JCD profile at step 70. At step 72, the specified profile is set as the active JCD profile. A determination is then made at decision block 74 as to whether or not the active JCD profile persists. As illustrated by step 76, if the JCD profile does not persist, the active JCD profile reverts back to the previous active JCD profile after the imaging job is completed. Alternatively, as illustrated by step 78, if the JCD profile does persist, the specific profile is maintained as the active JCD profile after the imaging job is completed.

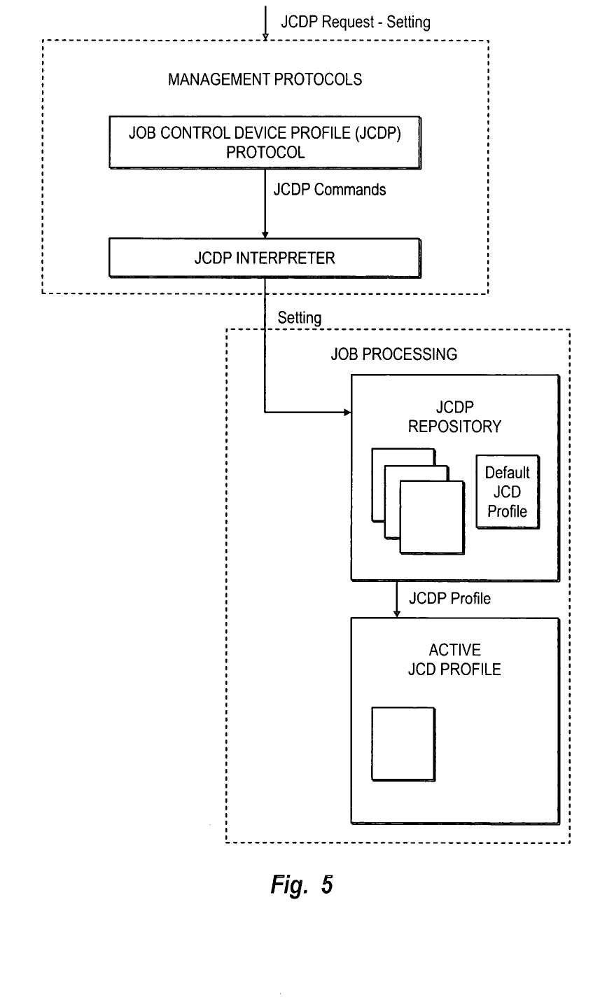

The JCDP request for setting the active JCDP profile to the JCDP interpreter may come through the management protocol module via the network interface, through the job processing module when the request is embedded in the imaging job, or the like. FIG. 5 illustrates a representative management protocol interface for setting a job control device profile.

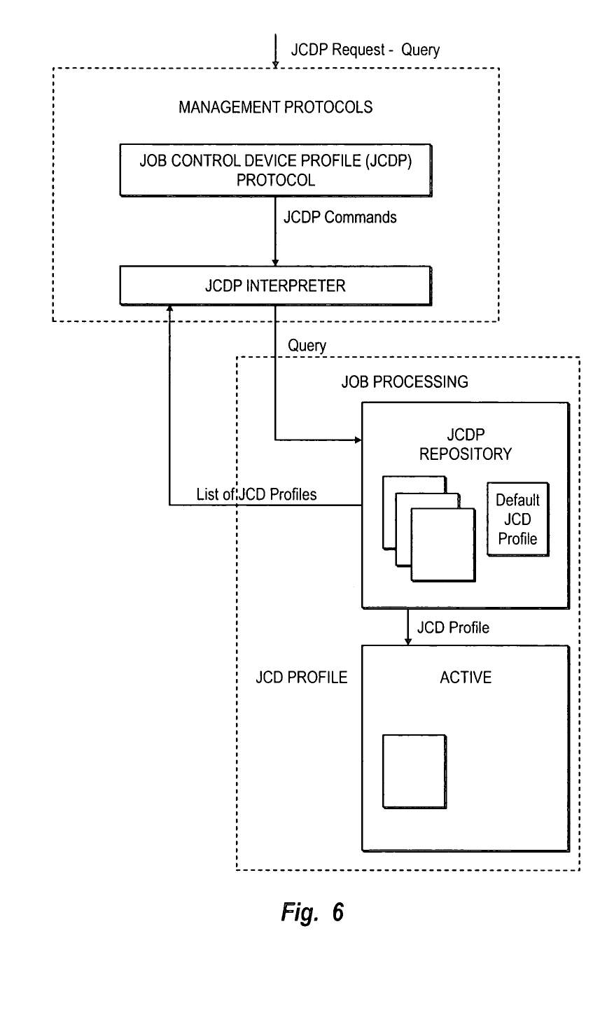

As illustrated in FIG. 6, a user may obtain from the imaging device a list of the installed (i.e., downloaded) JCD profiles and the identification of the default and active JCD profile. As illustrated, a JCDP request query may come through the management protocol module to the JCDP protocol handler and JCDP interpreter. The JCDP interpreter obtains from the repository the names/identification of all of the JCD profiles in the repository and the identification of the active and default JCD profile. This information is then returned to the user as a response to the JCDP request.

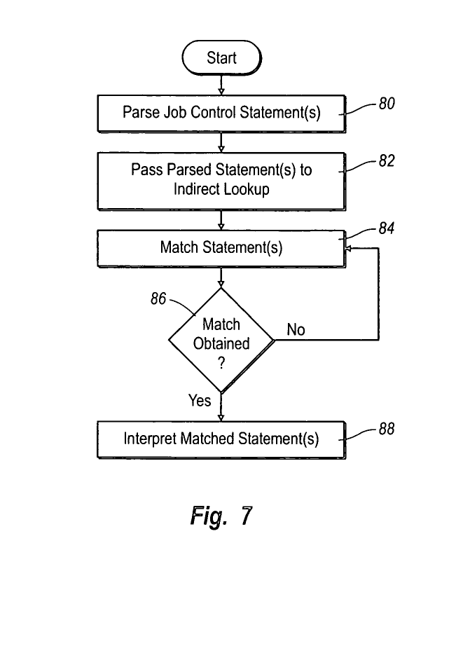

A job control interpreter may be decomposed into, for example, a statement parser, an indirect statement lookup, an active JCD profile, a statement execution and a unit setting. With reference to FIG. 7, a flow chart is provided that relates to representative processing for a job control device profile statement lookup. At step 80, the statement parser parses each individual job control statement in the imaging job. In one embodiment, the job control statements from one imaging device model to another imaging device model follow the same language syntax. For example, the format of the job control statements for imaging jobs is a PJL syntax. In an alternate embodiment, the syntax/format of the job control statements varies. Accordingly, the JCD profile contains additional information on how to parse the job control statements into individual job control statements. For example, the additional information defines the job control statement delimiters (e.g., newline, semi-colons, fixed format).

At step 82, the statement parser passes each parsed job control statement to the indirect statement lookup. At step 84, the indirect statement lookup matches the statement to a statement mapping specified in the active JCD profile. The lookup/matching may be performed by an exact match, a wild card, a variable substitution, or in another manner. For an exact match, the parsed job statement exactly matches a statement in the active JCD profile. For a wild card, the parsed job statement exactly matches a statement in the active JCD profile after wild card substitutions between the two statements are processed. For a variable substitution, the parsed job statement exactly matches a statement in the active JCD profile after variable substitution between the two statements are processed (i.e., copy count).

At decision block 86, a determination is made as to whether or not a match is obtained. If it is determined at decision block 86 that a match is not obtained, execution returns back to step 84. When a match is made, the JCD profile also contains information on how to interpret the matched statement, as illustrated by step 88. The information includes, for example, how to interpret any variable input or fixed operands (e.g., portrait/landscape for page orientation), what capabilities and settings are specified by this job command, and the like.

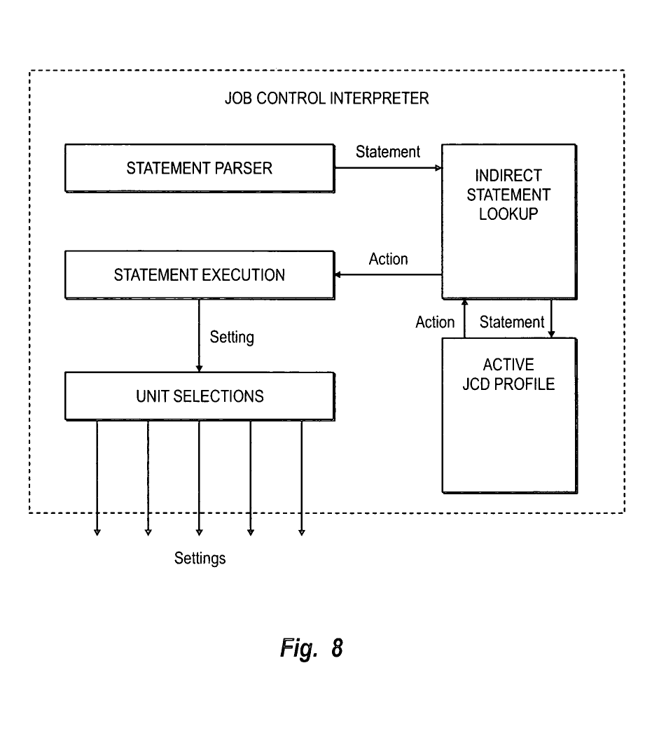

FIG. 8 illustrates a statement interpretation through an indirect statement lookup. The interpretation of the variable input/fixed operands may be performed either by the indirect statement lookup or by the statement execution. Finally, the above information of settings per capability is used by the statement execution to instruct the unit setting to send messages (e.g., signals) to one or more units that correspond to the settings per capability.

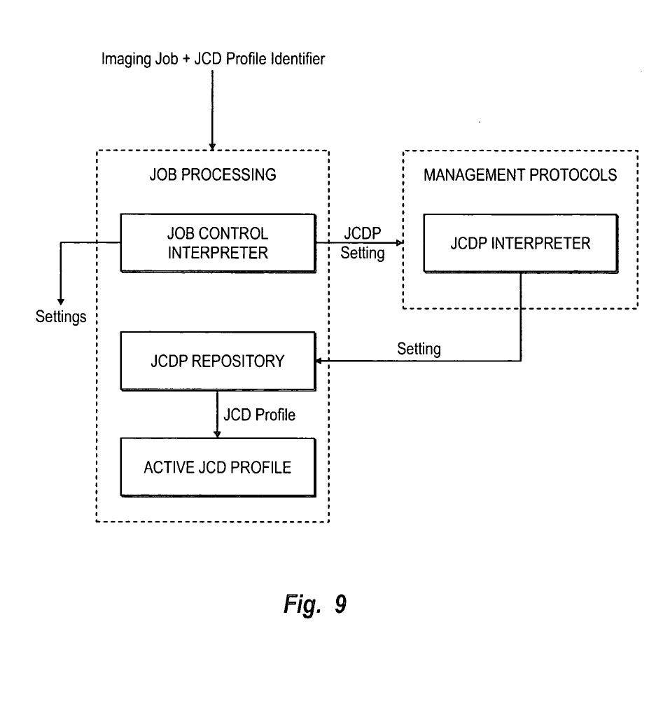

In one embodiment of setting the JCD profile, the JCD profile setting is embedded within the imaging job, as illustrated in FIG. 9. In the illustrated embodiment, the JCD profile is active only for the imaging job in which it is embedded. The specifying of the JCD profile within an imaging job can either be implicit or explicit. When it is implicitly specified, an imaging job includes information identifying the source origination. In the case where the source origination contains the identification of the imaging driver, the imaging identification driver may be used to lookup and set the JCD profile from the JCDP repository. In another embodiment, where the JCD profile is not in the JCDP repository, the imaging device downloads the JCD profile from another JCDP repository (e.g., centralized JCDP server, another imaging device, etc.) When it is explicitly specified, the job interpreter supports a job control command for specifying the JCD profile. The job control sequence in such an imaging job might look like:

@PJL SET JCDP=<printer model A>
@PJL SET DUPLEX=ON
...

The first job control statement is interpreted as part of the imaging device's built in (hard-coded) imaging language. The statement instructs the job interpreter to then use the JCD profile associated with <printer model A> for interpretation of all of the remaining job control commands. There is no limitation implied that an active JCD profile must replace all job control command interpretation. Instead, the active JCD profile may (i) replace the entire command set; (ii) replace a subset with the remainder interpreted by the default JCD profile; or (iii) add to the command set with the remainder interpreted by the default JCD profile.

In some embodiments, the imaging job includes more than one JCD profile setting command. In such embodiments, the first JCD profile setting command is the active JCD profile until another JCD profile setting command is encountered.

In another embodiment, the setting of the JCD profile includes having the JCD profile is submitted/set through the management protocol interface. One such example is a web based submission. In this example, the imaging device maintains a web page whereby a JCD profile can be downloaded, set or queried. A user then performs JCDP requests via the imaging device's web page(s). In another embodiment, the JCD profile is submitted to the device in a manner that appears as a non-rendering job submission (e.g., using PJL commands to download the profile into the firmware and/or filesystem).

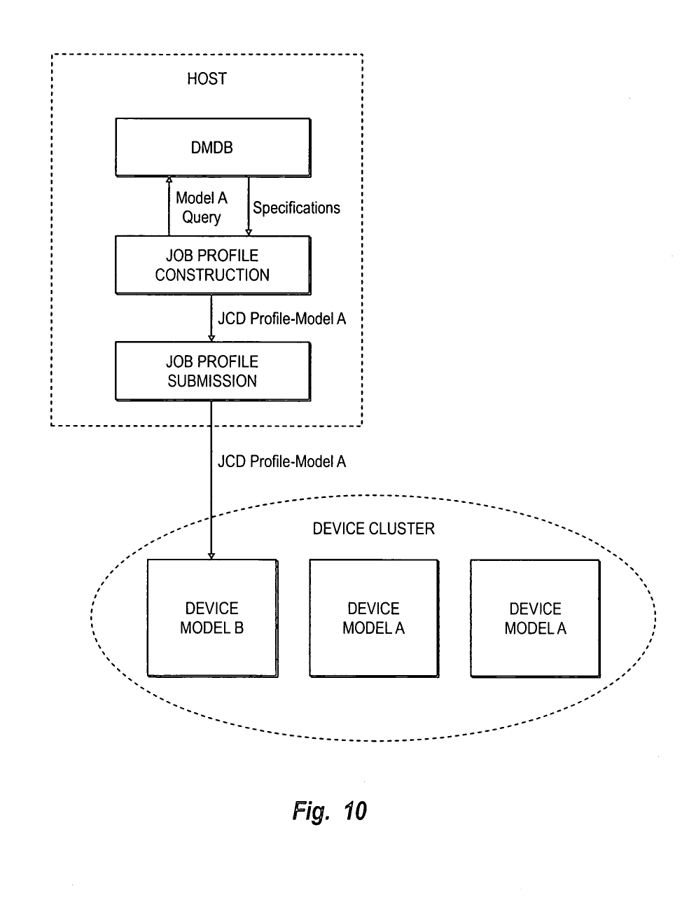

FIG. 10 illustrates a job control device profile set via a job control device profile submission protocol. In FIG. 10, a device cluster includes three imaging devices, two of model A, and one device of model B. For clustering purposes, the user chooses to have the cluster appear homogeneous by making model A appear as model B, using an embodiment of this invention.

In this example, the host computing device includes means for generating a JCD profile for model A. In the illustrated example, the host has a device model database (DMDB) that describes the information necessary to generate such a profile. A JCD profile construction process (e.g., utility) queries the DMDB for model B and obtains the information necessary for the profile construction. The JCD profile construction then constructs the profile and, via a JCD profile submission tool (e.g., web page), downloads and sets the JCD profile for model A to the device model B.

While embodiments of the present invention embrace spooling and despooling subsystems of the Microsoft® Windows operating systems, other embodiments embrace the Apple® Macintosh operating systems, Linux® operating systems, System V Unix® operating systems, BSD Unix® operating systems, OSF Unix® operating systems, and IBM® Mainframe MVS and AS/400 operating system, and the like. Further other embodiments embrace other information processing components of an imaging device, such as management protocols (e.g., SNMP, Device Web Pages) may also be implemented using an indirect lookup (e.g., Management Device Profile). Moreover, the page processing components of an imaging job (e.g., PDL), such as PCL commands, may also be implemented using an indirect lookup.

Thus, as discussed herein, the embodiments of the present invention embrace providing a homogeneous image rendering environment. In particular, the present invention relates to systems and methods for enabling an arbitrary imaging device with compatible capabilities appear homogeneous in an environment with other imaging devices, wherein the arbitrary imaging device would otherwise be considered heterogeneous due to differences in the control of the operations of the various devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. In a system that includes a heterogeneous imaging device, a method for enabling the heterogeneous imaging device to operate as a homogeneous device, the method comprising:
initiating an imaging job that is compatible with an imaging driver for rendering within the system;
using a virtual job control interpreter at the heterogeneous imaging device to render at least a portion of the imaging job, wherein the virtual job control interpreter uses a job control device profile that is compatible with the imaging driver for mapping job control commands into one or more internal job control actions; and
rendering the at least a portion of the imaging job at the heterogeneous imaging device.

2. A method as recited in claim 1, wherein the heterogeneous imaging device is preloaded with a default job control device profile that is compatible with the imaging driver.

3. A method as recited in claim 1, wherein the job control device profile is downloaded to the heterogeneous imaging device.

4. A method as recited in claim 3, wherein the job control device profile is based on another imaging device.

5. A method as recited in claim 1, wherein the job control device profile is selected at run-time for compatibility with the heterogeneous imaging device.

6. A method as recited in claim 1, wherein the job control device profile is dynamically set to conform to another imaging device.

7. A method as recited in claim 1, wherein the imaging job is one of:
(i) a print job;
(ii) a scan job;
(iii) a fax job; and
(iv) a document management job.

8. A method as recited in claim 1, wherein the step for using the virtual job control interpreter comprises:
parsing job control commands from the imaging job; and
establishing settings of the heterogeneous imaging device according to requirements specified by the job control commands.

9. A method as recited in claim 8, wherein the step for using the virtual job control interpreter further comprises at least one of:
parsing job control commands from the imaging job;
parsing page control commands from the imaging job; and
parsing page rendering commands from the imaging job.

10. A method as recited in claim 1, wherein the step for using the virtual job control interpreter comprises:
defining one or more capabilities of the heterogeneous imaging device;
defining capability settings associated with each of the one or more capabilities;
mapping a set of job control statements to the capability settings; and
utilizing a common definition interface to specify the capability settings and the one or more capabilities.

11. A method as recited in claim 1, wherein the step for using the virtual job control interpreter comprises:
extracting the job control device profile embedded in the imaging job; and
using a name of the job control device profile and a name of the heterogeneous imaging device to index and retrieve the job control device profile.

12. A method as recited in claim 1, wherein the step for initiating the imaging job is performed at a computer device that includes the imaging driver.

13. A homogeneous imaging system comprising:
a computing device configured to initiate an imaging job, wherein the client computing device is coupled to a network;
the imaging job, wherein the imaging job is compatible with an imaging driver; and
a heterogeneous imaging device coupled to the network, wherein the heterogeneous imaging device includes a virtual job control interpreter to render at least a portion of the imaging job, and wherein the virtual job control interpreter uses a job control device profile that is compatible with the imaging driver for mapping job control commands into one or more internal job control actions to render the at least a portion of the imaging job at the heterogeneous imaging device.

14. A homogeneous imaging system as recited in claim 13, wherein the heterogeneous imaging device is preloaded with a default job control device profile that is compatible with the imaging driver.

15. A homogeneous imaging system as recited in claim 13, wherein the job control device profile is downloaded to the heterogeneous imaging device.

16. A homogeneous imaging system as recited in claim 13, further comprising a homogeneous imaging device coupled to the network, wherein the homogeneous imaging device and the heterogeneous device are at least a part of an imaging cluster to selectively render imaging jobs.

17. A homogeneous imaging system as recited in claim 16, wherein the job control device profile is based on the homogeneous imaging device.

18. A homogeneous imaging system as recited in claim 13, wherein the imaging job is one of:
(i) a print job;
(ii) a scan job;
(iii) a fax job; and
(iv) a document management job.

19. A homogeneous imaging system as recited in claim 13, wherein the computing device includes the imaging driver.

20. A computer program product for implementing within a computer system a method for enabling the heterogeneous imaging device to operate as a homogeneous device within the cluster, the computer program product comprising:
a computer readable medium for providing computer program code means utilized to implement the method, wherein the computer program code means is comprised of executable code for implementing the steps for:
initiating an imaging job that is compatible with an imaging driver for rendering within the system;
utilizing a virtual job control interpreter at a heterogeneous imaging device of the system to render at least a portion of the imaging job, wherein the virtual job control interpreter uses a job control device profile that is compatible with the imaging driver for mapping job control commands into one or more internal job control actions; and
rendering the at least a portion of the imaging job at the heterogeneous imaging device.

21. A computer program product as recited in claim 20, wherein the computer program code means is further comprised of executable code for implementing a step for downloading the job control device profile to the heterogeneous imaging device.

22. A computer program product as recited in claim 21, wherein the job control device profile is based another imaging device.

23. A computer program product as recited in claim 20, wherein the computer program code means is further comprised of executable code for implementing a step for receiving the job control device profile as a selection at run-time for compatibility with the heterogeneous imaging device.

24. A computer program product as recited in claim 20, wherein the step for utilizing the virtual job control interpreter comprises:
parsing job control commands from the imaging job; and
establishing settings of the heterogeneous imaging device according to requirements specified by the job control commands.

25. A computer program product as recited in claim 24, wherein the step for utilizing the virtual job control interpreter further comprises at least one of:
parsing job control commands from the imaging job;
parsing page control commands from the imaging job; and
parsing page rendering commands from the imaging job.

26. A computer program product as recited in claim 20, wherein the step for utilizing the virtual job control interpreter comprises:
defining one or more capabilities of the heterogeneous imaging device;
defining capability settings associated with each of the one or more capabilities;
mapping a set of job control statements to the capability settings; and
utilizing a common definition interface to specify the capability settings and the one or more capabilities.

27. A computer program product as recited in claim 20, wherein the step for utilizing the virtual job control interpreter comprises:
extracting the job control device profile embedded in the imaging job; and
using a name of the job control device profile and a name of the heterogeneous imaging device to index and retrieve the job control device profile.
